(19) United States
(12) Patent Application Publication
(10) Pub. No.: US 2021/0329851 A1
(43) Pub. Date: Oct. 28, 2021

(54) APPARATUS AND SYSTEM FOR GROWING A PLURALITY OF PLANTS AS A MULTIPLICITY OF INDIVIDUAL, SEPARABLE UNITS

(71) Applicant: Trellis Growing Solutions LLC, Fort Wayne, IN (US)

(72) Inventor: Richard C. Barnes, Fort Wayne, IN (US)

(73) Assignee: Trellis Growing Solutions LLC, Fort Wayne, IN (US)

(21) Appl. No.: 17/238,380

(22) Filed: Apr. 23, 2021

Related U.S. Application Data
(60) Provisional application No. 63/014,778, filed on Apr. 24, 2020.

(51) Int. Cl. A01G 9/14; A01G 25/02; A01G 25/16

(52) U.S. Cl. CPC A01G 9/14; A01G 25/16; A01G 25/02

(57) ABSTRACT

A system for growing a plurality of plants, including a support apparatus having a plurality of upright frames and a plurality of substantially parallel wires extending longitudinally between the upright frames above a base surface. The wires are placed in tension to support laterally therebetween a multiplicity of individual, separable bags containing plants. Cultivation of the plants is facilitated by the apparatus with the supported bags positioned in a minimally spaced arrangement relative to each other at an ergonomic height above the base surface.

### CROSS REFERENCE TO RELATED APPLICATIONS

This is a non-provisional application based upon U.S. provisional patent application Ser. No. 63/014,778, entitled “SYSTEM FOR GROWING A PLURALITY OF PLANTS AS A MULTIPLICITY OF INDIVIDUAL, SEPARABLE UNITS”, filed Apr. 24, 2020, which is incorporated herein by reference.

### BACKGROUND OF THE INVENTION

### 1. Field of the Invention

The present invention relates to apparatus and systems for growing plants, and more particularly for such apparatus and systems that have plants in close proximity and may be adapted for sale and shipping in kit form.

### 2. Description of the Related Art

When growing plants on a commercial or hobby scale, there is always the concern that plants requiring maintenance during the growing season be placed so that they are ergonomic for the growers or workers who tend to the plants. This is especially true for some varieties of plants, such as strawberries, where maintenance is required throughout the growing season. If plants are located in the ground, the bending of a grower or worker to tend the plants may create back issues. Furthermore, when plants are grown on a commercial or hobby scale, there is a desire to place the plants as close to one another as is practical to provide the greatest density of plants per surface area taken up by the growing apparatus. This may be an especially difficult issue with some growing installations since they can be located in an urban environment and even on a rooftop.

What is needed in the art is an apparatus and a system for growing plants in a compact area and to place the plants in an ergonomic position for growers or workers.

### SUMMARY OF THE INVENTION

The present invention provides apparatus and a system that supports plants in a compact arrangement in a position that is ergonomic for maintenance during the growing season.

The invention, in one form, is directed to apparatus for supporting a plurality of plant containers by a plurality of upright frames spaced from one another and supported on a base surface. At least a pair of wires extends in a spaced substantially parallel relationship to one another between and supported by the spaced upright frames above the base surface. A device is configured for placing the wires in tension between the upright frames so that the plant containers are supported in minimally spaced relationship between the wires.

The invention, in another form, is directed to apparatus for supporting a plurality of plant containers. The apparatus has a plurality of upright and supported frames spaced from one another on the base surface with at least a pair of wires extending in a spaced, substantially parallel spaced relationship between the frames above the base surface. A device is configured for placing the wires in tension between the upright frames so that the plant containers are supported in a minimally spaced relationship. Structure is provided for supporting an irrigation system adjacent and above the spaced parallel wires.

In still another form, the invention is directed to apparatus for supporting a plurality of plant containers. The apparatus has a plurality of upright frames spaced from one another and supported on a base surface with at least a pair of wires extending in a spaced, substantially parallel relationship between the upright frames above the base surface. A device is configured for placing the wires in tension so that plant containers are supported in a minimally spaced relationship between the wires. An adjustable frame is provided above the upright frames to support a moveable lighting system.

One advantage is that plants may be placed in a flexible but minimally spaced relationship to one another

Another advantage is that the plants may be efficiently and effectively irrigated.

Still another advantage is that the plants may be maintained above a base surface at an ergonomic height.

Another advantage is that the plants may be efficiently removed from between the supporting wires for over wintering.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a perspective view of a plant container support apparatus in accordance with an exemplary embodiment of the present invention;

FIG. 2 is an enlarged fragmentary view of the apparatus illustrated in FIG. 1;

FIG. 3 is an enlarged fragmentary view of the apparatus illustrated in FIG. 1 showing support of a plant container;

FIG. 4 is a perspective view of a plant container support apparatus in accordance with another exemplary embodiment of the present invention;

FIG. 5 is a partial exploded perspective view of the apparatus shown in FIG. 4;

FIG. 6 is an enlarged fragmentary view of the apparatus shown in FIG. 4;

FIG. 7 is a perspective view of a cover and irrigation system for the plant container support apparatus of FIG. 1 or FIG. 4;

FIG. 8 is an expanded fragmentary view of a bracket utilized in the cover and irrigation system of FIG. 7;

FIG. 9 is a perspective view of an lighting system for the plant support apparatus of FIG. 1 or FIG. 4; and

FIG. 10 is a greatly expanded perspective view of an adjustable hanger utilized in the lighting system of FIG. 10.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The embodiment of the present invention described below is not intended to be exhaustive or to limit the invention to any precise embodiment disclosed in the following detailed description. Rather, the embodiment is chosen and described so that others skilled in the art may appreciate and understand the principles and practices of the present invention.

Exemplary system, apparatus and/or method embodiments according to the present disclosure are discussed below in detail with reference to the accompanying figures. In the following detailed description, numerous specific details are set forth in order to provide a thorough understanding of the present invention. It will, however, be obvious to those of ordinary skill in the relevant art that the present invention may be practiced without these specific details. In other instances, well-known structures are not shown in detail in order to avoid unnecessary obscuring of the present invention.

Furthermore, there is no intention to be bound by any expressed or implied theory presented in the preceding technical field, background, brief summary or the following detailed description. It is also to be understood that the specific embodiment illustrated in the attached figures and described herein is simply exemplary of the inventive concepts defined by the appended claims. Hence, specific dimensions and other physical characteristics relating to the embodiments disclosed herein are not to be considered as limiting, except as claimed.

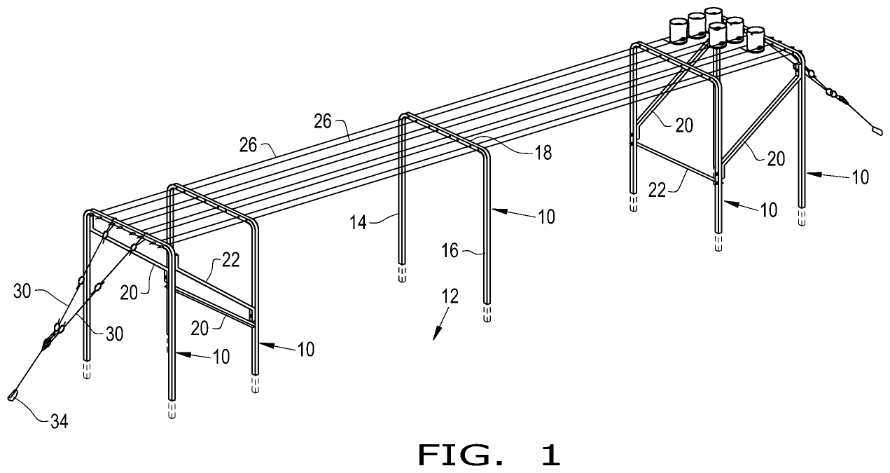

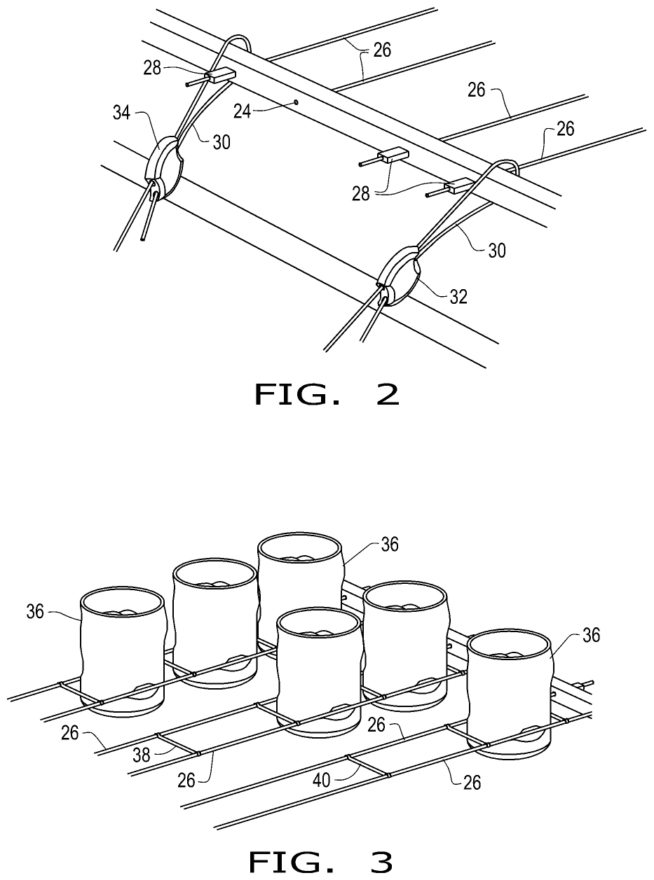

FIGS. 1 and 2 illustrate a plant container support apparatus. A plurality of upright frames 10 are spaced from one another in approximately a vertical orientation and are supported in a ground surface 12 by an appropriate foundation support. The upright frames 10 have a pair of vertical legs 14 and 16 interconnecting with a horizontal section 18. As illustrated, the upright frames 10 may be formed from tubular metal having a square shape cross-section but other configurations may be employed, including solid structural construction. The upright frames 10 forming the end pieces, as illustrated in FIG. 1, are paired with adjacent upright frames 10 and structurally interconnected by angle braces 20 and a cross brace 22. The angle braces 20 and cross brace 22 may be formed from similar tubular material and structurally connected with appropriate fasteners 23.

As particularly illustrated in FIG. 2, each horizontal section 18 has pairs of through holes 24 which receive wire 26 extending through in between adjacent upright frames. Through holes 24 are spaced and oriented so that the wires form substantially parallel pairs with which to support a plant container as described below. The wire 26 may be provided in a continuous strand that runs the length of the adjacent upright frames, including doubling back or it may be provided in individual sections. In either case, a tensioner 28 is provided adjacent and abutting the horizontal section 18 to provide the appropriate tension to enable a support of a plant container. The tensioner 28 may take a number of forms having the object of gripping the wire 26 and holding it in tension against the horizontal section 18. One example of such a connector is sold under the trademark Gripple from Gripple Ltd., The Old West Gun Works, Saville Street, East Sheffield, S4 7UQ, England.

Since the vertical legs 14 and 16 of the upright frames 10 are typically secured in the ground, in order to maintain the structure in an upright vertical position and stabilize the structure, guywire 30 may be provided at the end most upright frames 10. The guywire 30, as illustrated, may wrap around the horizontal section 18 with a guywire tensioner 32 and then lead to an anchor 34 secured in the ground 12. The guidewire tensioners 32 may be also a Gripple connector that allows the appropriate structural support of the end most upright frames 10. Alternatively, the end-most frames 10 may have a permanent foundation in the ground.

The plant container support apparatus illustrated in FIGS. 1 and 2 may be assembled using variable numbers of individual upright frames to achieve an overall assembly length of over 100 feet or a shorter length depending on the number of upright frames 10. The upright frames 10 may be positioned so that the horizontal leg is approximately 3 feet above ground level and the frames are spaced approximately 8 feet apart. The height has been recommended as an ergonomic height for maintenance of plants during the planting, growing and harvesting season. There may be more or less parallel sets of wires according to individual needs. The wire 26 is maintained in tension to resist lateral deformation. Although different levels of tension may be employed, it has been found that approximately 50 pounds is suitable for the purposes of supporting plant containers. The wire 26 may be in the form of a single 12 ½ gauge high tensile, galvanized steel wire or in multiple strands of galvanized steel wires, for example with cables formed from seven strands of 3/32″ galvanized steel wires.

The plant container support apparatus of FIGS. 1 and 2 is used to support a plurality of plant containers 36 shown in FIG. 1 and in expanded fashion in FIG. 3. The plant containers 36 may take the form of a soft permeable fabric container or bag that contains soil and a plant. One example of such a container is found in the commercially available Smart Bag™ that may be used with the system, or as a component of the system. As shown, the support wires 26 engage and compress the sides of the plant containers 36. The plant containers 36 are then supported by parallel wires 26 on opposite sides of the container 36 to support the plant container 36 between adjacent wires 26 and above the base surface 12. This enables the plant containers 36 to be positioned closely adjacent one another in a minimally spaced distance to enable a greater concentration of plants. By arranging the various pairs of wires 26 in side-by-side elongated relationship, the plant containers are easily accessed by a grower or worker tending the plants. The flexibility of the bag 36 allows it to expand over the wires 26 and thus be held in place. If it is necessary to resist displacement of the wires 26 away from one another adjacent the plants, a wire stay 38 may be provided which coils around adjacent wires 26 and extends between them adjacent the plant containers 36. Another form may include a link 40 that has an appropriate downward facing recess on its ends to capture the wires 26 and resist displacement of the wires 26 away from one another.

An advantage of the above arrangement is that with certain plants that are over wintered, preferably at ground level, the wires 26 allow the plant container 36 to be deformed and dropped down to ground level over the winter and appropriately protected. This enables proper winter protection, but at the same time permits the plants to be placed between the wires 26 during the growing season to place them at an efficient ergonomic elevation.

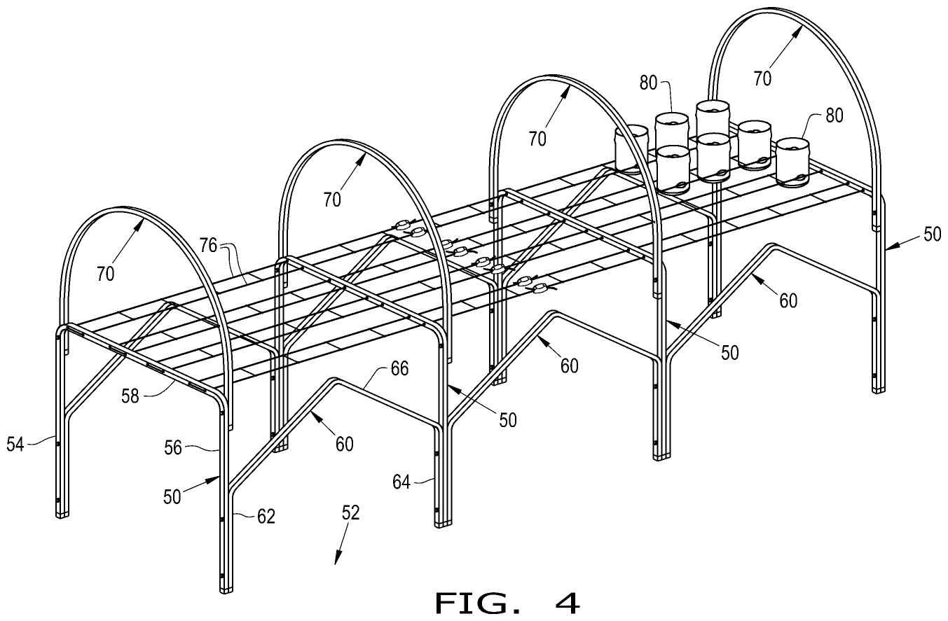

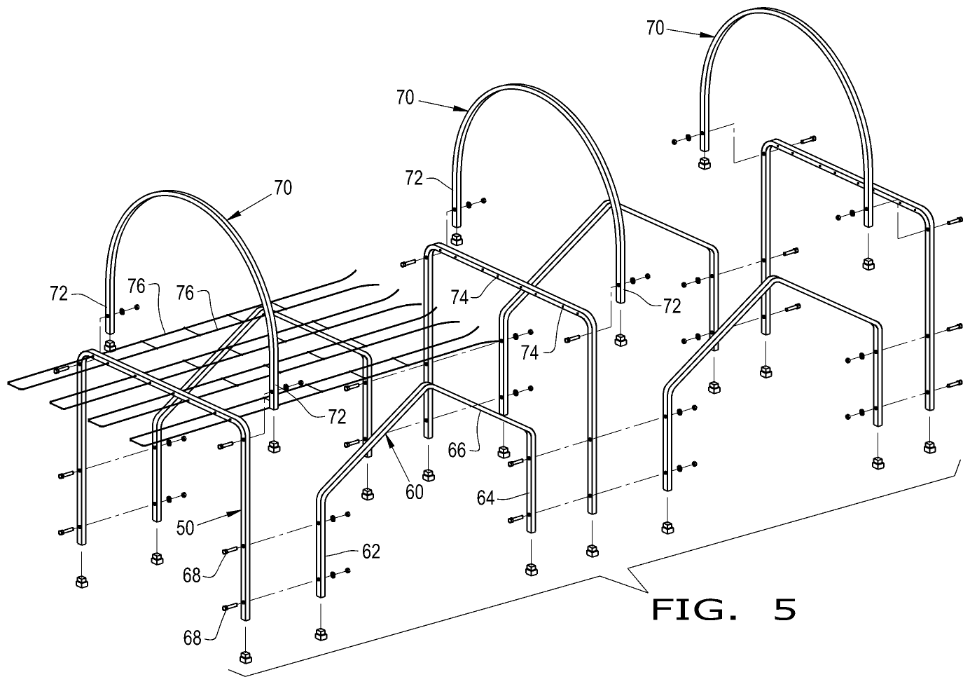

The plant container support apparatus of FIGS. 1-3 is typically utilized on a commercial basis in which the upright frames 10 are structurally supported and maintained upright independent of adjacent upright frames. This is advantageous for commercial growers having little space constraints for expanding the extent of the frames and the ready availability of soil in which the frames may be supported. The embodiments shown in FIGS. 4-6 show an arrangement where the upright frames are structurally interconnected so that the frame may be supported independent of a structural interconnection with a base surface other than resting on the surface. This is advantageous when the embodiment is employed in an urban setting where overall space is limited and the assembly may rest on a rooftop or other non-soil base surface.

Referring to FIGS. 4-6, there are a plurality of spaced upright frames 50 resting on a base surface 52. The upright frames 50 can be supported on the surface simply by gravity or may have additional interconnections to stabilize it in the lateral direction. The upright frames 50 include vertical legs 54 and 56 with a horizontal section 58 interconnecting the vertical legs 54 and 56. As stated previously, the upright frames 50 may be formed from solid material or preferably tubular material having a square or rectangular cross-section. Support braces 60 extend between adjacent spaced upright frames and include vertical legs 62 and 64 interconnected by a center section 66. As illustrated, the center section 66 has an inverted V configuration. It should be understood however that the center section 66 may be in other forms such as an arch or straight section. The support braces 60 are connected to the upright frames by fasteners 68 which may take one of many forms to structurally interconnect the frames 50. As illustrated, the upright frames 50 and the support braces 60 form a structural interconnection as a unified assembly. This allows the upright frames 50 to be spaced from one another and oriented in a substantially parallel relationship. They also, because of the structural interconnection, form part of the components for maintaining tension in wires 76 that pass through spaced pairs of through holes 74 in the horizontal frame portion 58. This provides pairs of substantially parallel extending wires 76 to support plant containers 80 in compact, spaced relationship.

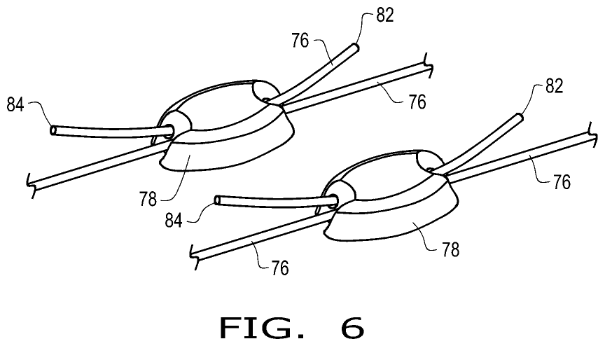

Because of the arrangement of the support braces between the upright frames 50, the need for bracing through guidewires at the ends of the interconnected upright frames 50 is not needed. In this case, the wires 76 may be threaded through and looped back though holes 74 and have a tensioner 78 acting against the upright frame 50 to maintain them in tension. Furthermore, one loop of wire 76 may be extended through adjacent frames looped back on itself in a U-shaped pattern to match with an adjacent string of wire 76. As shown in FIG. 6, the ends 82 and 84 of adjacent wires 76 may overlap one another and held in tension by the tensioner 78 to provide the appropriate level of tension for supporting the plant containers 80. It should be apparent to those skilled in the art that the wires 76 may be threaded through the holes 74 in any number of arrangements and held by tensioners 78 to maintain the appropriate tension level.

As is apparent from observation of the drawings, that both the embodiments of FIGS. 1-3 and 4-6 may be formed as substantially planar frame components so that they may be easily shipped to an end user and then assembled to their deployed length. In addition, the wires 26 and 76, when not in tension, have sufficient flexibility to maintain them in coils that also facilitate shipping to an end user. This is especially important for hobby use in urban and suburban environments.

The upright frames 50 may be provided with upper frames 70 having frame ends 72 that are appropriately fastened to vertical legs 62 and 64 with suitable fasteners. As illustrated, the upper frames 70 are shown in an arched configuration and may be formed from the same material as the upright frames 50. It should be apparent that the upper frames 70 may also have a V-shaped configuration, as appropriate.

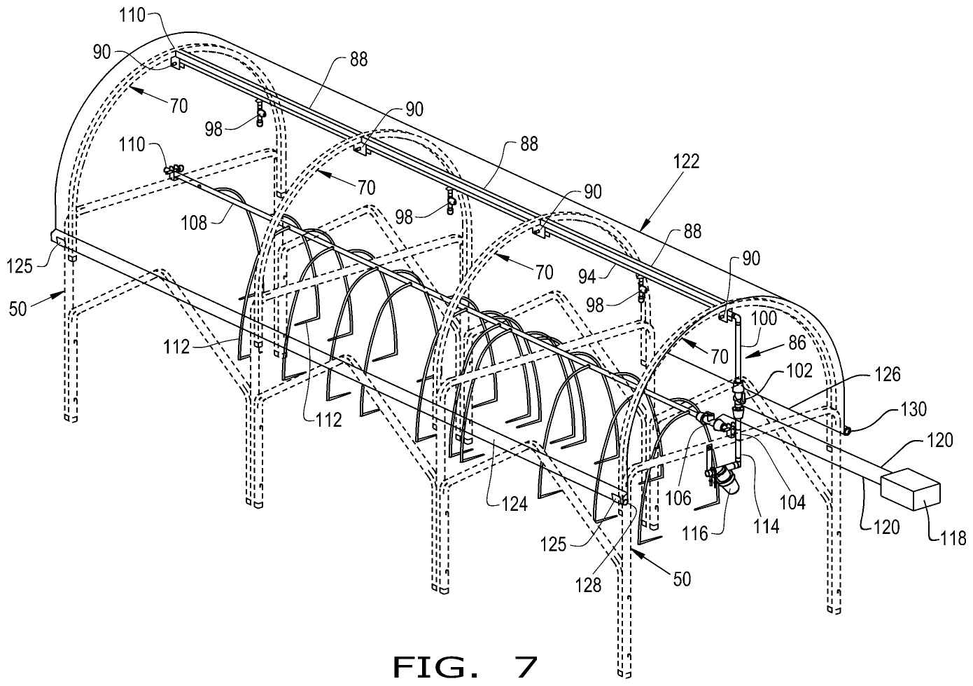

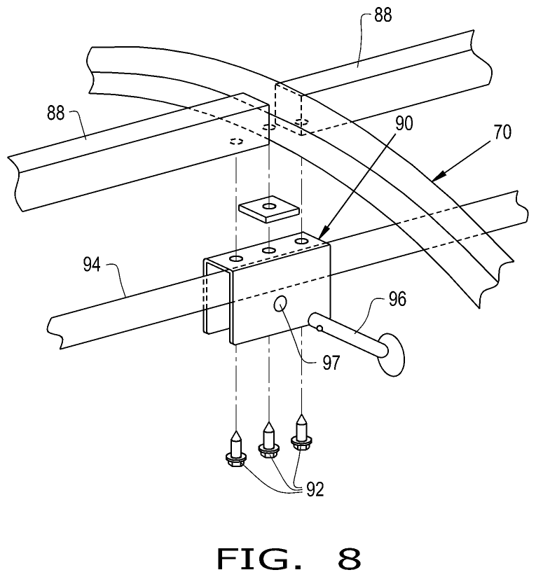

Referring to FIGS. 7 and 8, an irrigation system 86 may be employed with the plant container support apparatus shown in FIGS. 4 and 5. In addition, the irrigation system 86 may be employed with the configuration of FIGS. 1-3 with the mounting of the upper frames 70 to the upright frames 10 of FIGS. 1-3. The irrigation system 86 includes support frames 88 that extend between and are supported by the peaks of the upper frames 70. As shown particularly in FIG. 8, brackets 90 in the form of inverted U's are connected to the adjacent upper frame 70 and adjacent support frames 88 by appropriate fasteners 92. A mister supply line 94 runs longitudinally substantially parallel to the mister support frames 88 and is received in the brackets 90. Detent pins 96, shown particularly in FIG. 8, extend through holes 97 to capture and support the mister supply line 94. A plurality of misters 98 are fluidly connected to and supported by mister supply line 94. The misters 98 may be spaced appropriately for the plants received under them. A supply line 100 is connected to the mister supply line 94 by a right angle connection and extends downward to a valve 102. Valve 102 in turn is connected to a T supply manifold 104 that also has connected to it a valve 106. Valve 106 extends to emitter supply line 108 that extends longitudinally through the plant container support apparatus. Appropriate plugs 110 seal off the remote end of the mister supply line 94 and the emitter supply line 108. A plurality of emitter tubes 112 are fluidly connected to the emitter supply line 108 and are used to provide irrigation to plants contained within the plant container support apparatus. A supply line 114 leads from the T-shaped supply manifold and includes a filter/regulator 116. The filter/regulator 116 is connected to an appropriate source of irrigation liquid.

The irrigation system 86 may be controlled manually or automatically and may include timed irrigation or moisture controlled irrigation as is apparent to those skilled in the art. Furthermore, the valves 102 and 106 may be manually or electronically controlled by a microprocessor 118 through electrical lines 120. In certain system embodiments according to the present invention, the controller 118, may be a programmable microprocessor-controlled computer, of a known type commercially available from Hunter Industries, which may be configured to be powered by a solar panel and battery.

The irrigation system 86 provides efficient and direct interconnection with the existing plant container support apparatus so that the location of the supply lines provide for most efficient irrigation of the plants. For extended lengths of the plant container support apparatus, it should be noted that pressure compensators may be employed to maintain uniform flow throughout the irrigation lines.

Referring again to FIG. 7, the plant container support apparatus may include a cover 122 formed from standard, 6 mil, translucent poly material (such as polyethylene) commonly used in greenhouses. In addition to the 6 mil poly, the cover 122 may be a reinforced polyethylene or shade netting. The cover 122 extends over the upper frames 70 along the length of the plant container support apparatus and terminates in tubes 124 and 126. Tubes 124 and 126 are secured to the edges of the material 122 so that when the tubes 24 and 126 are rotated, they roll up the cover 122 to expose plants to direct sunlight. When the tubes 124 and 126 are in the position adjacent the support frames 88, they may be held in that position by appropriate means such as Velcro fastening. Preferably, the tubes 124 and 126 have end receptacles 28 and 130, respectively, that may receive a crank handle or other device (not shown) to rotate them and facilitate rolling of the cover 122 to its upper position. In their lower position, the tubes 124 and 126 are held by upwardly facing U-shaped clips 125 fixed to upright frames 50 and upper frames 70 through appropriate fasteners. The arrangement showing the cover in FIG. 7 may also be employed in the embodiment set forth in FIGS. 1-3 by connecting the upper frames 70 to the upright frames 10.

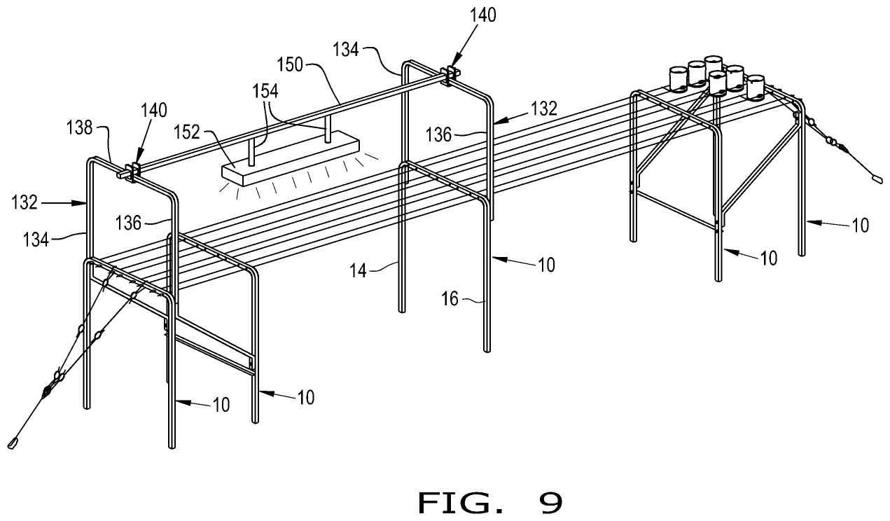

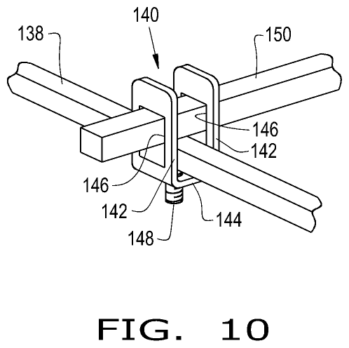

Referring now to FIGS. 9 and 10, there is shown an arrangement for indoor growing of plants. Although it is shown in connection with the embodiments of the invention shown in FIGS. 1-3, it may also be employed in the embodiment shown in FIGS. 4-7. In this arrangement, upper frames 132 have vertical legs 134, 136 interconnected by a horizontal section 138. As is the implementation of the other frame members, the upper frames 132 may be formed from square cross section tubing, although other cross section configuration may be also employed. The vertical legs 134 and 136 are connected to upright frames 10 through appropriate fasteners to hold them in place substantially as a vertical extension of the upright frames 10. A U-shaped hanger bracket 140 faces upward, as illustrated, to hang from a light support frame 150 that lays over horizontal frame 138. As shown in an expanded view of hanger bracket 140 in FIG. 10, the U-shaped bracket 140 has legs 142 interconnected by a center section 144. In each leg there is formed an aligned opening 146, herein shown in rectangular form to accommodate square tubing. A set screw 148 is threadedly engaged with center section 144 to secure the horizontal frame 138 and a light support frame 150 interconnected in a cross fashion. Light support frame 150 is connected to an appropriate grow light 152 through vertical posts 154. Because of the hanger bracket 140, the position of the grow light 152 may be flexibly and adjustably moved in a direction of parallel to the longitudinal axis of the plant support apparatus and in a direction at right angles. The setscrew 148 enables efficient loosening and tightening for this purpose.

Hence, according to the present disclosure a system is provided for growing a plurality of plants as a multiplicity of individual, separable units supported by the apparatus. Certain embodiments of the system include components adapted for sale, shipment and delivery in the form of a kit. The kit components are adapted for assembly into a unit-supporting structure capable of positioning the supported units in a minimally spaced arrangement relative to each other and in which the system facilitates cultivation of the plants.

Persons skilled in the art will appreciate that there are yet more alternative implementations and modifications possible, and that the above examples are only illustrations of one or more implementations which can be further modified within the spirit and scope of this disclosure. This application is therefore intended to cover any such departures from the present disclosure as come within known or customary practice in the art to which the invention pertains and/or variations, uses, or adaptations of the invention using its general principles that fall within the scope of the claims appended hereto, which is only to be limited by the appended claims and any amendments made thereto.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. Apparatus for supporting a plurality of plant containers, comprising:
a plurality of upright frames spaced from one another and supported on a base surface;
at least a pair of wires extending in a spaced, substantially parallel relationship to one another between and supported by said spaced upright frames above the base surface; and
a device configured for placing said wires in tension between said upright frames whereby the plant containers are supported in minimally spaced relationship between said at least a pair of wires and above the base surface.

2. The apparatus as claimed in claim 1, further comprising elongated elements extending transversely between said at least a pair of wires for resisting displacement of the wires away from each other.

3. The apparatus as claimed in claim 2, wherein the spacing device is one of a wire extending transversely between adjacent wires and coiled around each of them and an elongated element extending between the wires and having a recess with which to capture adjacent wires.

4. The apparatus as claimed in claim 1, wherein said upright frames are provided with holes through which said at least a pair of wires extend to be supported in substantially parallel relationship to one another.

5. The apparatus as claimed in claim 4, wherein said upright frames have a tubular cross-section and are formed in the shape of an inverted U with upright extending legs.

6. The apparatus as claimed in claim 4, wherein the base surface is the ground and upright frames the legs of said U-shaped tubular frames extend into the ground.

7. The apparatus as claimed in claim 6, wherein said tension device maintains the tension of said at least a pair of wires relative to said upright frames and the end-most upright frames of said plurality are anchored in the ground.

8. The apparatus as claimed in claim 7, wherein the end upright frames and an adjacent upright frame are structurally interconnected.

9. The apparatus as claimed in claim 5, further comprising interconnecting structure between said upright frames to establish spacing and to maintain said upright frames self-supporting on the ground surface.

10. The apparatus as claimed in claim 4, wherein said tensioning device comprises an element capturing said at least a pair of wires and abutting an upright frame to maintain a tension in the wire.

11. The apparatus as claimed in claim 10, wherein wire extends through multiple frames to be maintained in tension with a single capturing element.

12. The apparatus as claimed in claim 4, further comprising a top portion in the form of an inverted U-shaped configuration and fixed to said upright frame members.

13. The apparatus as claimed in claim 12, further comprising a movable cover extending between and over said upper U-shaped frames.

14. The apparatus as claimed in claim 13, further comprising a device for rolling up the cover about an axis extending substantially parallel to said at least a pair of wires.

15. The apparatus as claimed in claim 12, further comprising interconnecting frame members at the peak of said upper U-shaped frames for supporting an irrigation system.

16. The apparatus as claimed in claim 15, further comprising a bracket in the form of an inverted U affixed to said interconnecting frames and the upper frames and having a removable pin for receiving a mister irrigation tube extending between adjacent upper frames.

17. The apparatus as claimed in claim 16, further comprising an irrigation system comprising:
a upper mister supply line received in and supported in said U-shaped bracket;
a lower emitter supply line extending substantially parallel to the upper mister supply line;
a main supply fluidly connected to said upper mister supply line and lower emitter supply lines; and,
a control system for controlling supply of fluid to the upper mister supply line and the lower emitter supply line for supplying mister and emitter irrigation for plants supported in the plant containers.

18. The apparatus as claimed in claim 4, further comprising:
an upper frame in the form of an inverted U-shaped configuration having a horizontal upper section and fixed to said upright frames;
a U-shaped bracket having an elongated through opening; and,
an elongated support frame extending between adjacent upper frames, one of the horizontal upper section and the elongated support frame extending through the holes and the other at right angles to form a T connection, said bracket further having a set screw to adjustably secure the frame and horizontal upper section relative to one another, whereby the elongated support frame may be adjustably positioned.

19. The apparatus as claimed in claim 18, further comprising a grow light connected to a longitudinal support frame so that it may be adjusted in two dimensions relative to the plant containers.

20. A plant growing system comprising:
a plurality of upright frames spaced from one another and supported on a base surface;
at least a pair of wires extending in a spaced, substantially parallel relationship to one another between and supported by said spaced upright frames above the base surface;
a device configured for placing said wires in tension between said upright frames; and
a plurality of flexible plant containers supported between said at least a pair of wires in a minimally spaced relationship.
